(19) United States
(12) Patent Application Publication
(10) Pub. No.: US 2022/0022693 A1
(43) Pub. Date: Jan. 27, 2022

(54) CONTAINER FOR FOOD PROCESSING SYSTEM

(71) Applicant: SharkNinja Operating LLC, Needham, MA (US)

(72) Inventors: Matt Roberts, Medfield, MA (US); Edward Lockyer, Pimlico (GB); Kristof Benedict Fogarasi, Norwood, MA (US); Nicholas M. O'Loughlin, Lantau Island (HK); Fredrick Ko, Shatin (HK); Yaoming Deng, Shenzhen (CN); Audithan Huang, Needham, MA (US); John Jiang, Shenzhen (CN); Lucas Lai, Shenzhen (CN); Gang Chen, Huizhou (CN); Kevin Pei, Shenzhen (CN); Sam Bannister, Kent (GB)

(73) Assignee: SharkNinja Operating LLC, Needham, MA (US)

(21) Appl. No.: 17/383,040

(22) Filed: Jul. 22, 2021

Related U.S. Application Data
(60) Provisional application No. 63/057,201, filed on Jul. 27, 2020.

(51) Int. Cl. A47J 43/06; A47J 43/07; A47J 43/046

(52) U.S. Cl. CPC A47J 43/06; A47J 43/046; A47J 43/0722

(57) ABSTRACT

An attachment configured for use with a food processing system includes a container configurable with a food processing base of the food processing system. The container has a processing chamber. The processing chamber has a first configuration adjacent a first end of said container and a distinct second configuration adjacent a second end of said container, said second configuration being circular.

### CROSS-REFERENCE TO RELATED APPLICATIONS

This application claims priority to and benefit of co-pending U.S. Provisional Application No. 63/057,201, filed Jul. 27, 2020, entitled CONTAINER FOR FOOD PROCESSING SYSTEM, the entire contents of which are incorporated herein by reference for all purposes.

### FIELD

Embodiments of the present disclosure relate generally to a food processing system, and more particularly to a container suitable for use with the food processing system and configured to receive one or more food items therein.

### BACKGROUND

Blenders are commonly used to process a plurality of different food products, including liquids, solids, semi-solids, gels and the like. It is well-known that blenders are useful devices for blending, cutting, and dicing food products in a wide variety of commercial settings, including home kitchen use, professional restaurant or food services use, and large-scale industrial use. They offer a convenient alternative to chopping or dicing by hand, and often come with a range of operational settings and modes adapted to provide specific types or amounts of food processing, e.g., as catered to particular food products.

### SUMMARY

According to an embodiment, an attachment configured for use with a food processing system includes a container configurable with a food processing base of the food processing system. The container has a processing chamber. The processing chamber has a first configuration adjacent a first end of said container and a distinct second configuration adjacent a second end of said container, said second configuration being circular.

In addition to one or more of the features described above, or as an alternative, in further embodiments a cross-sectional area of said first configuration of said processing chamber is greater than a cross-sectional area of said second configuration of said processing chamber.

In addition to one or more of the features described above, or as an alternative, in further embodiments said first configuration is one of square, rectangular, rectellipse, and squircle in shape.

In addition to one or more of the features described above, or as an alternative, in further embodiments comprising a processing tool receivable within said processing chamber, said processing tool being rotatable about an axis.

In addition to one or more of the features described above, or as an alternative, in further embodiments said processing tool includes at least a first blade positionable within a portion of said processing chamber having said second configuration and a second blade positionable within a transitional portion of said processing chamber between said first configuration and said second configuration.

In addition to one or more of the features described above, or as an alternative, in further embodiments a distance between said first blade and a sidewall of said processing chamber is less than a distance between said second blade and said sidewall of said processing chamber.

In addition to one or more of the features described above, or as an alternative, in further embodiments said processing tool is selected from a plurality of interchangeable processing tools suitable for use with said container.

In addition to one or more of the features described above, or as an alternative, in further embodiments said plurality of interchangeable processing tools includes a first processing tool operable to perform a chopping operation and a second processing tool operable to perform a mixing operation.

In addition to one or more of the features described above, or as an alternative, in further embodiments said first processing tool has a stacked 6-blade configuration and said second processing tool has a dough 4-blade configuration.

In addition to one or more of the features described above, or as an alternative, in further embodiments said first processing tool is rotatable about said axis at a first speed and said second processing tool is rotatable about said axis at a second speed.

According to another embodiment, a food processing system includes a food processing base and an attachment connectable to said food processing base. The attachment includes a container and at least one processing tool receivable within said container. The food processing system is operable in both a food processing mode and a blending mode. The attachment is connectable to said food processing base during both said food processing mode and said blending mode.

In addition to one or more of the features described above, or as an alternative, in further embodiments during said food processing mode said at least one processing tool is rotatable about an axis at at least 300 rpm.

In addition to one or more of the features described above, or as an alternative, in further embodiments during said food processing mode said at least one processing tool is rotatable about an axis at at least 500 rpm.

In addition to one or more of the features described above, or as an alternative, in further embodiments during said food processing mode said at least one processing tool is rotatable about an axis at a speed between about 1000 rpm and 1500 rpm.

In addition to one or more of the features described above, or as an alternative, in further embodiments during said blending mode said at least one processing tool is rotatable about an axis at at least 1000 rpm.

In addition to one or more of the features described above, or as an alternative, in further embodiments during said blending mode said at least one processing tool is rotatable about an axis at at least 3000 rpm.

In addition to one or more of the features described above, or as an alternative, in further embodiments during said blending mode said at least one processing tool is rotatable about an axis at a speed between about 5000 rpm and 6000 rpm.

In addition to one or more of the features described above, or as an alternative, in further embodiments said at least one processing tool includes a first processing tool receivable within said container during said food processing mode and a second processing tool receivable within said container during said blending mode.

In addition to one or more of the features described above, or as an alternative, in further embodiments said first processing tool has a stacked 6-blade configuration.

In addition to one or more of the features described above, or as an alternative, in further embodiments said second processing tool has a dough 4-blade configuration.

In addition to one or more of the features described above, or as an alternative, in further embodiments said at least one processing tool includes a single food processing tool receivable within said container during both said food processing mode and said blending mode.

According to another embodiment, a food processing system includes a food processing base and an attachment connectable to said food processing base. The attachment includes a container and at least one processing tool receivable within said container. The at least one processing tool is rotatable about an axis at a speed between about 300 rpm and about 20,000 rpm.

In addition to one or more of the features described above, or as an alternative, in further embodiments said at least one processing tool includes a first processing tool, said first processing tool being associated with a food processing operation

In addition to one or more of the features described above, or as an alternative, in further embodiments said first processing tool is rotatable about said axis at at least 300 rpm.

In addition to one or more of the features described above, or as an alternative, in further embodiments said first processing tool is rotatable about said axis at at least 500 rpm.

In addition to one or more of the features described above, or as an alternative, in further embodiments said first processing tool is rotatable about said axis at between about 1000 rpm and 1500 rpm.

In addition to one or more of the features described above, or as an alternative, in further embodiments said at least one processing tool includes a second processing tool interchangeable with said first processing tool, said second processing tool being associated with a blending operation.

In addition to one or more of the features described above, or as an alternative, in further embodiments said second processing tool is rotatable about said axis at at least 1000 rpm.

In addition to one or more of the features described above, or as an alternative, in further embodiments said second processing tool is rotatable about said axis at at least 3000 rpm.

In addition to one or more of the features described above, or as an alternative, in further embodiments said first processing tool is rotatable about said axis at between about 5000 rpm and 6000 rpm.

In addition to one or more of the features described above, or as an alternative, in further embodiments said container defines a chamber and said chamber has a first cross-sectional shape at a first end and a second cross-sectional shape at a second end.

### BRIEF DESCRIPTION OF THE FIGURES

The accompanying drawings incorporated in and forming a part of the specification embodies several aspects of the present disclosure and, together with the description, serves to explain the principles of the disclosure. In the drawings:

FIG. 1 is a perspective view of a food processing system according to an embodiment;

FIG. 2 is a perspective view of a base of a food processing system according to an embodiment;

FIG. 3 is a cross-sectional view of a container of an attachment suitable for use with a food processing system according to an embodiment;

FIG. 4 is a schematic diagram of a control system of a food processing system according to an embodiment;

FIG. 5 is a perspective view of an attachment suitable for use with a food processing system according to an embodiment;

FIG. 6 is a plan view of a container of the attachment of FIG. 5 according to an embodiment;

FIG. 7 is a cross-sectional view of the container of FIG. 6 taken along line 7-7 according to an embodiment;

FIG. 8 is a partial cross-sectional view of the attachment of FIG. 5 according to an embodiment; and

FIG. 9 is a partial cross-sectional view of the attachment of FIG. 5 according to another embodiment.

The detailed description explains embodiments of the disclosure, together with advantages and features, by way of example with reference to the drawings.

### DETAILED DESCRIPTION

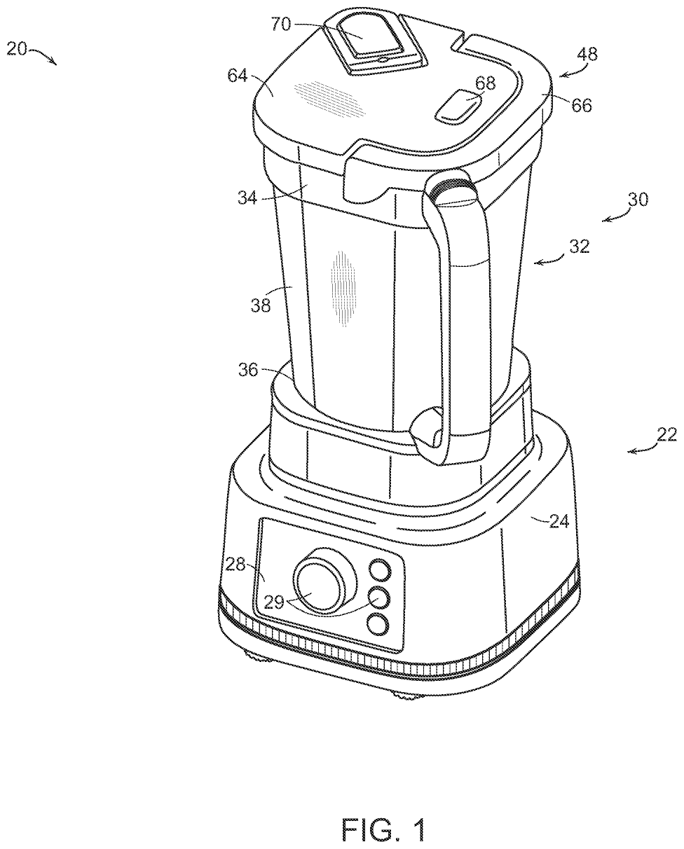

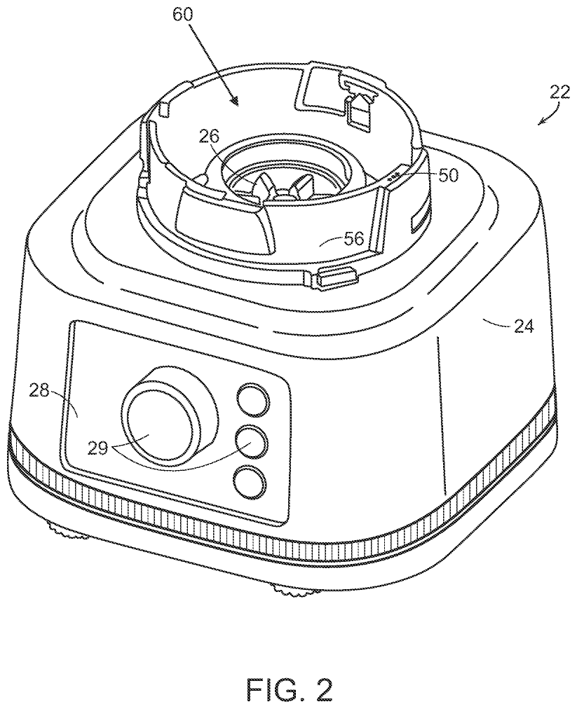

Referring now to FIGS. 1 and 2, an example of a multi-functional food processing system 20 is illustrated. In general, the food processing system 20 can be adapted to perform any food processing or blending operation including as non-limiting examples, dicing, chopping, cutting, slicing, mixing, blending, stirring, crushing, or the like. Although the food processing system 20 illustrated and described herein is a blender system, other food processing systems are within the scope of the present disclosure.

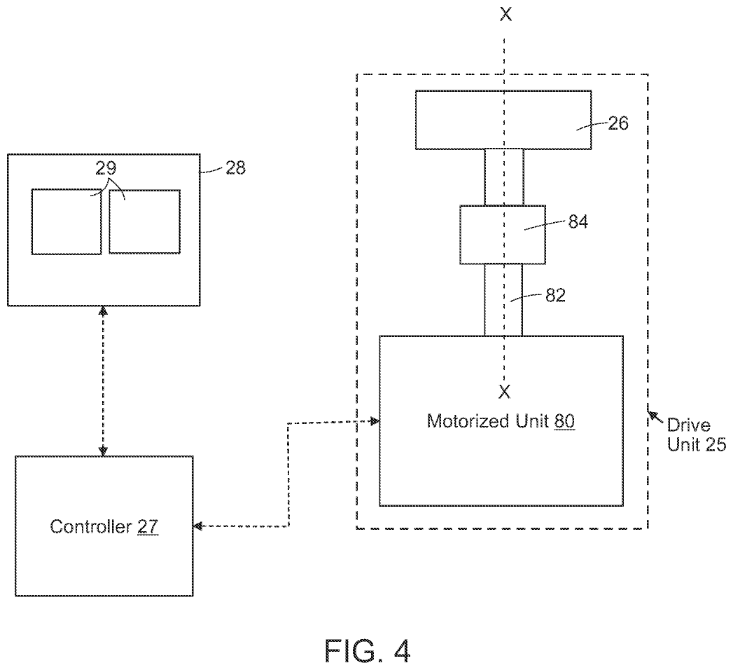

The food processing system 20 includes a food processing base 22 having a body or housing 24 within which a drive unit 25 (see FIG. 4) and at least one controller 27 are located. The drive unit 25 includes at least one rotary component, such as a drive coupler 26 (see FIG. 2) for example, driven by a motorized unit 80 located within the housing 24. The base 22 additionally includes a control panel or user interface 28 having one or more inputs 29 for turning the motorized unit 80 on and off and for selecting various modes of operation, such as pulsing, blending, or continuous food processing. The at least one drive coupler 26 is configured to engage a portion of an attachment coupled to the base 22 for the processing of food products located within an interior of the attachment. This will become more apparent in subsequent FIGS. and discussion.

One or more attachments 30 varying in size and/or functionality may be configured for use with the base 22. An example of an attachment 30 suitable for use with the base 22 is illustrated in FIG. 1. As shown, the attachment 30 includes a container 32, such as a pitcher or jar for example. In some embodiments, the container 32 may be sized to hold approximately 72 fluid ounces. However, embodiments where the container 32 has a larger or smaller capacity are also within the scope of the disclosure. As shown, the container 32 typically includes a first open end 34, a second closed end 36, and one or more sidewalls 38 extending between the first end 34 and the second end 36 to define a hollow processing chamber 40 of the container 32.

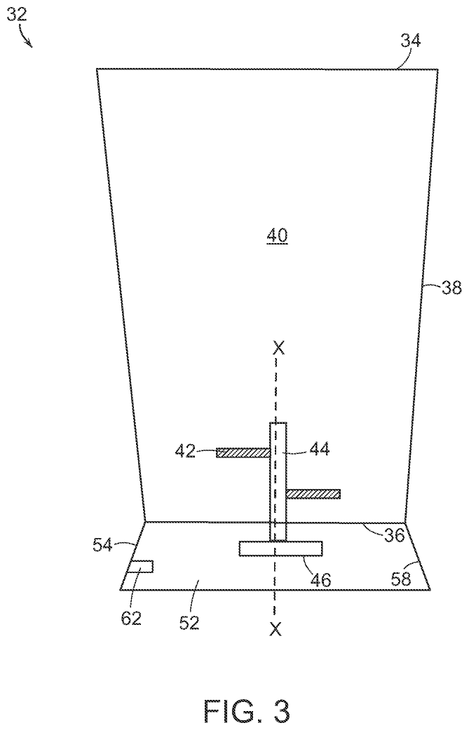

A rotatable processing tool 42 may be arranged within the processing chamber 40 to perform one or more food processing operations. The rotatable processing tool 42 may be integrally formed with the second end 36 of the container 32, or alternatively, may be removably mounted thereto. In embodiments where the processing tool 42 is separable from the container 32, the container 32 may include a spindle 44 (see FIG. 3) that protrudes from the second end 36 into the processing chamber 40. The spindle 44 is configured to rotate relative to the container 32 about an axis X and a processing tool 42 is positionable about the spindle 44 such that the processing tool 42 is rotatable with the spindle 44 about the axis of rotation X.

The processing tool 42 is configured to couple to the base 22 of the food processing system 20. A driven coupler 46 (FIG. 3) associated with the processing tool 42, or the spindle 44, is positioned at an underside of the container 32, outside of the processing chamber 40. The at least one drive coupler 26 is configured to engage the driven coupler 46 to rotate the processing tool 42 about an axis X to process the food products located within the processing chamber 40.

Further, the attachment 30 may additionally include a lid 48 configured to couple to the first open end 34 of the container 32 to seal the processing chamber 40. The second end 36 of the attachment 30 is configured to mount to the base 22 to perform a food processing operation. Accordingly, the orientation of the container 32 when the attachment 30 is connected to the base 22 and when the attachment 30 is separated from the base 22 remains generally constant.

The attachment 30 may be positionable in overlapping arrangement with a upwardly extending coupling wall 50 (see FIG. 2) of the base 22. With reference now to FIG. 3, In an embodiment, the at least one sidewall 38 of the container 32 extends beyond the second end 36 of the container 32 to define a coupling chamber 52 there between. As shown, the driven coupler 46 is disposed within the coupling chamber 52. In such embodiments, when connecting the container 32 to the base 22, the coupling wall 50 is receivable within the coupling chamber 52 of the container 32. In an embodiment, the configuration of the extended portion 54 of the sidewall 38 at the coupling chamber 52, such as the angle and/or length for example, is complementary to the coupling wall 50 such that an outwardly facing surface 56 of the coupling wall 50 directly contacts an interior surface 58 of the extended portion 54 of the sidewall 38. It should be understood that any attachment suitable for use with the base 22, regardless of the configuration of the attachment, may be either receivable within an interior 60 of the coupling wall 50, or alternatively, in overlapping arrangement with the coupling wall 50.

In an embodiment, the attachment 30 includes one or more contact members 62 for connecting to the container 32 to the base 22. The contact members 62 may be tabs or another protrusion positioned about the periphery the attachment 30. Further, although the contact members 62 are illustrated as extending inwardly from the interior surface 58 of the extended portion 54 of the sidewall, it should be understood that embodiments where one or more contact members 62 alternatively or additionally extend from another location of the container 32 are also within the scope of the disclosure. However, embodiments where the container 32 does not include any contact members are also contemplated herein.

The contact members 62 of the attachment 30 may be configured to cooperate with a mounting area of the base 22 to couple the attachment 30 to the base 22. In the illustrated, non-limiting embodiment, the coupling wall 50 may form the mounting area of the base 22. However, embodiments where the mounting area is arranged at another portion of the base, such as at the upper surface of the base 22 or within the interior 60 for example, are also contemplated herein. The mounting area may include one or more receiving slots (not shown) within which each of the plurality of contact members 62 of the attachment 30 is receivable. The attachment 30 may be configured to slidably connect to the base 22 of the food processing system 20. Alternatively or in addition, the attachment 30 may be configured to rotatably connect to the base 22. For example, the attachment 30 may be configured to rotate approximately 30 degrees between a configuration where the attachment 30 is separable from the base 22 and a configuration where the attachment 30 is locked relative to the base 22, such as during operation of the system for example. However, it should be understood that any suitable mechanism for coupling the attachment 30 to the base 22 is within the scope of the disclosure.

As previously noted, a lid 48 is connectable to the first end 34 of the container 32 to seal the contents within the processing chamber 40. The body 64 of the lid 48 configured to connect to the first end 34 of the container 32 may have a contour generally complementary in size and shape to the first end of the container 32. In an embodiment, a portion of a body 64 of the lid 48 is receivable within the interior of the container 32 and is configured to form a seal with an interior surface of the sidewall 38 of the container 32. The lid 48 may be configured to simply press fit to the first open end 34 of the container 32. However, in other embodiments, the lid 48 may be configured to selectively lock to the container 32. In the illustrated, non-limiting embodiment, the lid 48 includes a handle 66 movable between a first position and a second position. In the first position, the lid 48 is capable of being coupled to the container 32 by moving the lid 48 downwardly onto the container 32. When the lid 48 is coupled to and aligned with the top of the container 32, the handle 66 may be moved, for example rotated, to the second position, to lock the lid 48 to the container 32. Any fastening mechanism suitable for selectively locking the lid 48 to the container 32 is within the scope of the disclosure.

When locked, the lid 48 cannot be removed unless the handle 66 is moved out of the second position. The lid 48 may additionally include a release button 68 configured to unlock the lid 48 from the container 32. In one embodiment, once the handle 66 is in the second position and the lid 48 is locked to the container 32, the handle 66 is locked in the second position until the release button 68 is pressed.

The lid 48 may include an opening or pour spout (not shown) for pouring out at least a portion of the contents of the processing chamber 40 while the lid 48 is secured to the container 32. Although the pour spout opening is positioned at a corner of the lid 48 in the FIGS., the pour spout opening may be formed at any suitable location about the lid 48. In addition, a cover 70 may be movable, for example rotatable, relative to the remainder of the lid 48 to seal or expose the pour spout opening.

Further, the container 32 may include an actuator or component configured to engage and actuate a switch to permit operation of the motorized unit when the container 32 is connected to the base 22. It should be understood that the container actuator may be arranged at any suitable location about the container 32, including both inside or outside of the container 32. Further, the lid 48 may include a lid actuator movable into contact with the container actuator when the lid 48 is coupled to the container 32. Accordingly, the engagement between the lid actuator and the container actuator when the container actuator is coupled to the base 22 drives movement of the container actuator to permit activation of the motorized unit. The actuation system described herein is intended an as example only, and any suitable system for permitting operation of the motorized unit when the attachment is affixed to the base 22 is contemplated herein.

With reference now to FIG. 4, the drive unit 25 includes a centrally located drive shaft 82 rotatable about axis X in at least one direction, and in some embodiments, in both a first direction and a second, opposite direction. The drive coupler 26 is affixed to a portion of the drive shaft 82, such as an end thereof for example. Rotation of the drive shaft 82 is controlled by the motorized unit 80. In an embodiment, the motorized unit 80 may be directly coupled to the drive coupler 26, such that the drive coupler is rotated at the same speed as the drive shaft 82. Alternatively, the motorized unit 80 may be indirectly connected to the drive coupler 26, such as via a gearbox or transmission 84 for example (see FIG. 4), such that a rotational speed of the drive shaft 82 may, but need not be different, for example greater than or less than the rotational speed of the drive coupler 26. In such embodiments, the axis of the drive shaft 82, may be coaxial with the axis of the drive coupler 26. However, embodiments where the axis of the drive shaft 82 is offset from the axis of the drive coupler 26, in either a parallel or angled configuration, are also contemplated herein.

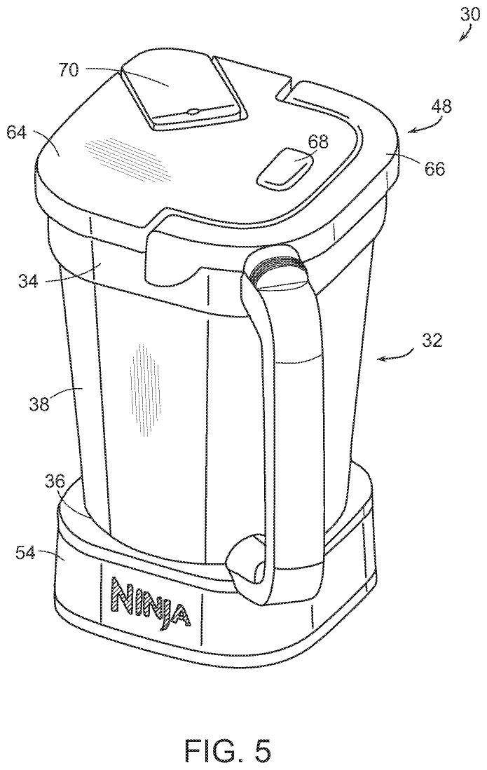

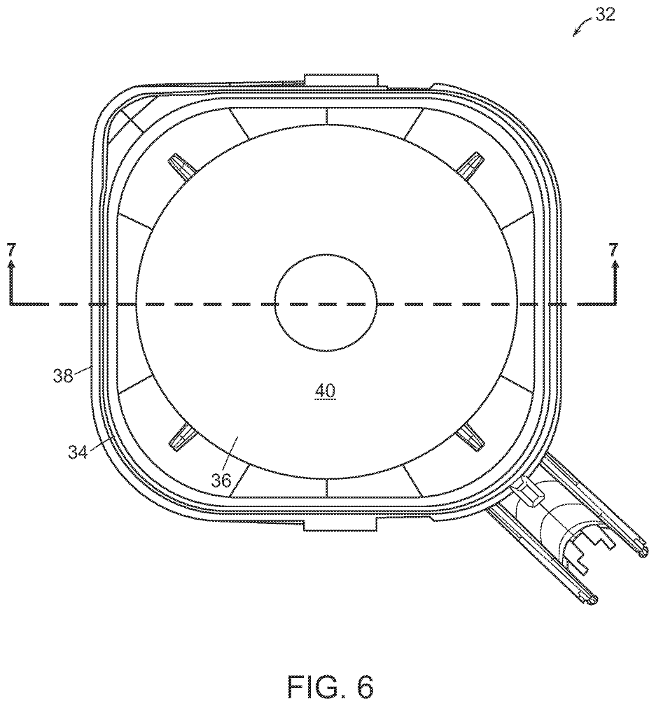

Traditional food processor pitchers typically have a circular or cylindrical processing chamber and traditional blender jars typically have a square or rectangular processing chamber. Unlike these existing food processing and blending containers, a cross-sectional shape of the container 32 of the attachment 30, when taken in a plane oriented perpendicular to the axis of rotation, varies over the height of the processing chamber 40. With reference now to FIGS. 5-9, the container 32 of the attachment 30 is illustrated in more detail. In an embodiment, a cross-sectional area of the processing chamber 40 decreases with the distance from the second end 36 of the container 32, thus promoting distribution of food products when the processing tool 42 rotates within the processing chamber 40. Further, as shown in FIG. 6, the processing chamber 40 of the container 32 may be symmetrical about any plane containing a centrally located axis of the container 32, such as the axis of rotation X of the processing tool 42 for example; however, at least a portion of the processing chamber 40, such as adjacent the first end 34 for example, is not axisymmetric about the axis X.

As shown, the processing chamber 40 has a first configuration adjacent the first end 34 of the container 32 and a second configuration adjacent the second, opposite end 36 of the container 32. In the illustrated, non-limiting embodiment, the first configuration of the processing chamber 40 is one of square, rectangle, rectellipse (rectangle with rounded corners), or squircle (square with rounded corners) and the second configuration of the processing chamber 40 is circular. The sidewalls extending between the first end 34 and the second end 36 of the container 32 are contoured to provide a gradual transition between the first configuration and the second configuration of the processing chamber 40 over the height of the container 32. In an embodiment, the at least one sidewall 38 of the container 32 tapers slightly inwardly toward the second end 36 of the container 32 to achieve this transformation in cross-sectional shape.

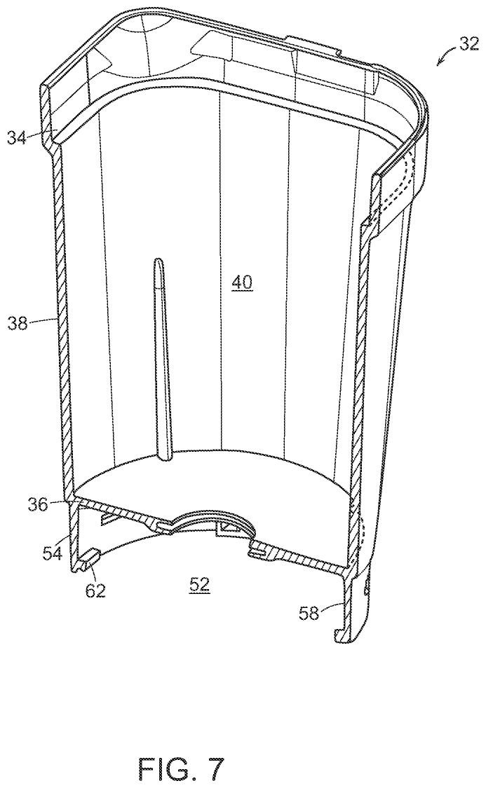

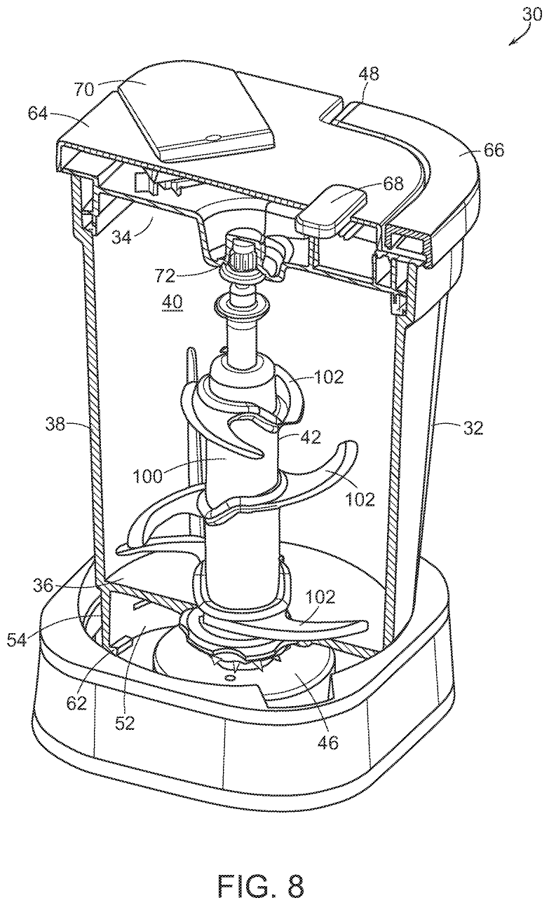

By forming the hollow interior of the container 32 to have a varying cross-sectional shape and area over its height, the attachment 30 may provide an all-in-one solution with superior blending, chopping, and dough mixing performance. This eliminates the need for consumes to use separate processing vessels based on the operation being performed and/or the processing tool 42 being used. Accordingly, the container 32 is suitable for use with a plurality of different processing tools 42. For example, the container 32 may be suitable for use with both a processing tool having a stacked blade configuration, such as a stacked 6-blade configuration (FIG. 7) and with a processing tool having a dough blade configuration, such as a 4-blade configuration (FIG. 8) for example. Although described herein with respect to a stacked 6-blade configuration and a dough 4-blade configuration, it should be understood that any combination of processing tools capable of performing blending, chopping, and dough processing operations are within the scope of the disclosure. For example, a processing tool 42 having any number of stacked blades, such as a 2-blade, 3-blade, 4-blade, 5-blade, 6-blade or more configuration and a dough processing tool having any number of blades, including but not limited to a 2-blade, 3-blade, 4-blade or more configuration is contemplated herein.

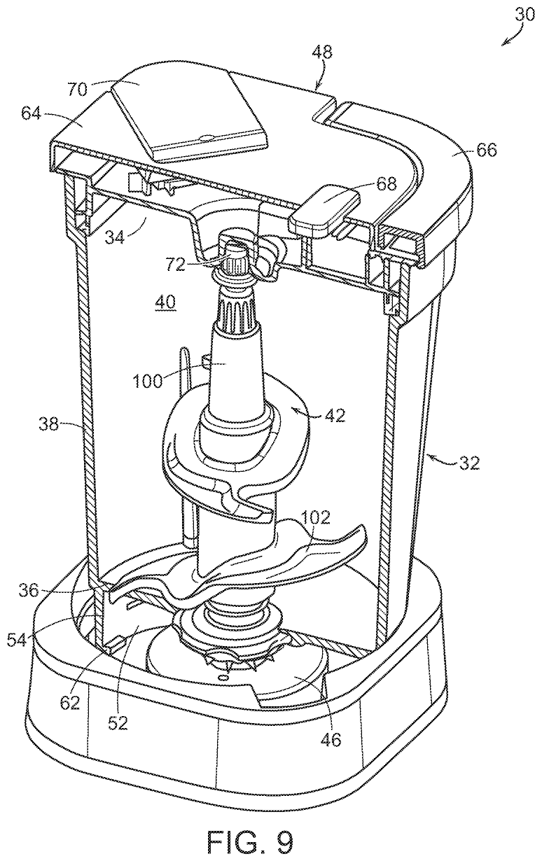

In an embodiment, when the processing tool 42 is mounted within the hollow chamber 40 of the container 32, such as in overlapping arrangement with the spindle 44 for example, a distal end of the processing tool 42 is configured to engage a portion of the lid 48. In an embodiment, best shown in FIGS. 8 and 9, the lid 48 includes an engagement element 72, such as a bushing for example, to facilitate rotation about the axis X at the interface between the processing tool 42 and the lid 48.

With reference to FIGS. 8 and 9, each of the processing tools 42 includes a shaft 100 having a plurality of blades 102 arranged in pairs that are spaced apart from one another over the length of the shaft 100. The blades 102 may be removably coupled to the shaft 100, or alternatively, may be permanently affixed to the shaft 100. In the illustrated, non-limiting embodiment of FIG. 8, the processing tool 42 includes three pairs of opposing blades 102. Similarly, the processing tool shown in FIG. 9 includes two pair of opposing blades 102. However, it should be understood that a processing tool 42 having any suitable number of blades 102, such as one pair, two pairs, or four or more pairs are also within the scope of the disclosure. Further, the blades 102 may be generally uniform in shape and size, and may extend from the shaft 100 the same radial distance. However, embodiments where at least one of the blades 102 of the processing tool 42 has a different configuration (size, shape, radial distance) than another of the blades 102 of the processing tool 42 are also contemplated herein. Further, the blades 102 may have sharp edges to facilitate cutting or chopping, or may be constructed to knead dough.

When the food processing system 20 is operated using the processing tool of FIG. 8, at least one blade 102 of the processing tool 42, such as a first pair of opposing blades 102, is arranged near the second end 36 of the container 32. Accordingly, the at least one blade 102 is positioned within the portion of the processing chamber 40 having the second, substantially circular cross section. Additionally, another blade 102 of the processing tool 42, such as a second pair of opposing blades for example, is positioned within the portion of the processing chamber 40 having the first configuration, such as the substantially square or squircle cross-section. As shown, a third pair of opposing blades 102 is arranged near a midpoint of the shaft 100 such that the third pair of opposing blades 102 is arranged at a portion of the processing chamber 40 having a transitional cross-section between the first configuration and the second configuration.

With respect to the processing tool of FIG. 9, at least one blade 102 of the processing tool 42, such as a first pair of opposing blades, is similarly arranged near the second end 36 of the container 32, within the portion of the processing chamber 40 having the second, substantially circular cross section. As shown, the processing tool 42 includes a second pair of opposing blades 102 located near a midpoint of the shaft 100. This second pair of blades 102 is therefore arranged at a portion of the processing chamber 40 having a transitional cross-section between the first configuration and the second configuration.

Because of the variation in the cross-sectional shape of the processing chamber 40 of the container 32, the blades 102 of each processing tool 42 may be positioned at different distances from the sidewall 38. For example, with reference to the processing tool 42 of FIG. 7, the at least one blade positioned adjacent the second end 36 of the container 32 may be a first distance from the sidewall 38, and the at least one blade positioned closest to the first end of the container 32 may be a second distance from the sidewall 38. In an embodiment, the second distance is greater than the first distance as a result of the transition in the cross-sectional shape of the processing chamber 40 over its height.

A processing tool suitable for use with a conventional food processing container is typically rotatable at slower rotational speeds than a processing tool configured for use with a blending container. However, in the illustrated, non-limiting embodiment, the container 32 is suitable for use with a processing tool configured to rotate at a speed associated with a food processing operation and also within a processing tool configured to rotate at a speed associated with a blending operation or blending mode. Accordingly, the processing tool 42 may be driven via a transmission 84. In an embodiment, the transmission may have a gear reduction ratio of between 5:1 and 2:1, and more specifically a gear reduction of about 3.1:1. However, any suitable gear reduction ratio, such as up to 20:1 for example, is contemplated herein.

When a processing tool 42 configured to perform a blending operation is coupled to the container 32, such as the processing tool having the stacked 6-blade configuration, the maximum rotational speed of the processing tool 42 driven by the motorized unit 80 may be approximately 20,000 rpm, and the minimum rotational speed of the processing tool 42 may be about 1000 rpm. In an embodiment, the actual rotational speed of a processing tool 42 suitable to performed a blending operation, such as the stacked 6-blade configuration for example, will be between about 3,000 rpm and about 10,000 rpm, and more specifically between about 4,000 rpm and 7,000 rpm or between 5000 rpm and 6000 rpm. Similarly, when a processing tool 42 configured to perform a food processing operation, such as the processing tool 42 having the dough 4-blade configuration for example, is coupled to the container 32, the maximum rotational speed of the processing tool 42 may be approximately 5,000 rpm, and the minimum rotational speed of the processing tool 42 may be about 100 rpm. In an embodiment, the actual rotational speed of the processing tool 42 will be between about 300 rpm and 3000 rpm, and more specifically, between about 500 and 2000 rpm, or between about 1000 rpm and 1500 rpm. The maximum rotational speed, minimum rotational speed, and actual rotational speeds of each of the processing tools 42 described herein represent speeds when the processing chamber 40 of the attachment is empty and therefore unloaded.

TABLE 1

| Processing | | Max | Min | Actual |
|---|---|---|---|---|
| Tool | Transmission | RPM | RPM | RPM |
| Stacked | Y (Gear | About | About | 5,000- |
| 6 blade | Reduction between | 20,000 | 1000 | 6,000 |
| (FIG. 7) | 5:1 and 2:1) | | | |
| Dough | Y | About | About | 1,000- |
| 4 blade | (Gear Reduction | 5,000 | 100 | 1,500 |
| (FIG. 8) | between 5:1 and | | | |
| | 2:1) | | | |

The processing tool 42 having a stacked 6-blade configuration may be rotated at a first speed to perform a blending operation, and may be rotated at a second, slowed speed to perform a chopping operation. Another processing tool 42, such as having a dough 4-blade configuration for example, is able to form a dough when rotated at a third speed. The third speed, may be generally equal to or may be different than the second speed. The various speeds achievable using a motorized unit 80 as described herein allow a container 32 to receive both a processing tool 42 suitable for performing a blending operation and a processing tool suitable for performing a food processing operation or mode. Accordingly, the container may be used to perform any of a blending operation, a chopping operation, and a dough processing operation therein. A container 32 capable of receiving a processing tool 42 suitable for performing each of these food processing operations does not currently exist.

The food processing system 20 illustrated and described herein provides an enhanced user experience by combining the functionality of several different attachments into a single attachment suitor use with a variety of processing tools.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Exemplary embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. An attachment configured for use with a food processing system, comprising:
a container configurable with a food processing base of the food processing system, the container having a processing chamber;
wherein said processing chamber has a first configuration adjacent a first end of said container and a distinct second configuration adjacent a second end of said container, said second configuration being circular.

2. The attachment of claim 1, wherein a cross-sectional area of said first configuration of said processing chamber is greater than a cross-sectional area of said second configuration of said processing chamber.

3. The attachment of claim 1, wherein said first configuration is one of square, rectangular, rectellipse, and squircle in shape.

4. The attachment of claim 1, further comprising a processing tool receivable within said processing chamber, said processing tool being rotatable about an axis.

5. The attachment of claim 4, wherein said processing tool includes at least a first blade positionable within a portion of said processing chamber having said second configuration and a second blade positionable within a transitional portion of said processing chamber between said first configuration and said second configuration.

6. The attachment of claim 5, wherein a distance between said first blade and a sidewall of said processing chamber is less than a distance between said second blade and said sidewall of said processing chamber.

7. The attachment of claim 4, wherein said processing tool is selected from a plurality of interchangeable processing tools suitable for use with said container.

8. The attachment of claim 7, wherein said plurality of interchangeable processing tools includes a first processing tool operable to perform a chopping operation and a second processing tool operable to perform a mixing operation.

9. The attachment of claim 8, wherein said first processing tool has a stacked 6-blade configuration and said second processing tool has a dough 4-blade configuration.

10. The attachment of claim 8, wherein said first processing tool is rotatable about said axis at a first speed and said second processing tool is rotatable about said axis at a second speed.

11. A food processing system comprising:
a food processing base; and
an attachment connectable to said food processing base, said attachment including a container and at least one processing tool receivable within said container;
wherein the food processing system is operable in both a food processing mode and a blending mode, said attachment being connectable to said food processing base during both said food processing mode and said blending mode.

12. The food processing system of claim 11, wherein during said food processing mode said at least one processing tool is rotatable about an axis at at least 300 rpm.

13. The food processing system of claim 11, wherein during said food processing mode said at least one processing tool is rotatable about an axis at at least 500 rpm.

14. The food processing system of claim 11, wherein during said food processing mode said at least one processing tool is rotatable about an axis at a speed between about 1000 rpm and 1500 rpm.

15. The food processing system of claim 11, wherein during said blending mode said at least one processing tool is rotatable about an axis at at least 1000 rpm.

16. The food processing system of claim 11, wherein during said blending mode said at least one processing tool is rotatable about an axis at at least 3000 rpm.

17. The food processing system of claim 11, wherein during said blending mode said at least one processing tool is rotatable about an axis at a speed between about 5000 rpm and 6000 rpm.

18. The food processing system of claim 11, wherein said at least one processing tool includes a first processing tool receivable within said container during said food processing mode and a second processing tool receivable within said container during said blending mode.

19. The food processing system of claim 18, wherein said first processing tool has a stacked 6-blade configuration.

20. The food processing system of claim 18, wherein said second processing tool has a dough 4-blade configuration.

21. The food processing system of claim 11, wherein said at least one processing tool includes a single food processing tool receivable within said container during both said food processing mode and said blending mode.

22. A food processing system comprising:
a food processing base; and
an attachment connectable to said food processing base, said attachment including a container and at least one processing tool receivable within said container, wherein said at least one processing tool is rotatable about an axis at a speed between about 300 rpm and about 20,000 rpm.

23. The food processing system of claim 22, wherein said at least one processing tool includes a first processing tool, said first processing tool being associated with a food processing operation.

24. The food processing system of claim 23, wherein said first processing tool is rotatable about said axis at at least 300 rpm.

25. The food processing system of claim 23, wherein said first processing tool is rotatable about said axis at at least 500 rpm.

26. The food processing system of claim 23, wherein said first processing tool is rotatable about said axis at between about 1000 rpm and 1500 rpm.

27. The food processing system of claim 23, wherein said at least one processing tool includes a second processing tool interchangeable with said first processing tool, said second processing tool being associated with a blending operation.

28. The food processing system of claim 27, wherein said second processing tool is rotatable about said axis at at least 1000 rpm.

29. The food processing system of claim 27, wherein said second processing tool is rotatable about said axis at at least 3000 rpm.

30. The food processing system of claim 27, wherein said first processing tool is rotatable about said axis at between about 5000 rpm and 6000 rpm.

31. The food processing system of claim 22, wherein said container defines a chamber and said chamber has a first cross-sectional shape at a first end and a second cross-sectional shape at a second end.
